(19) United States
(12) Patent Application Publication
(10) Pub. No.: US 2026/0283210 A1
(43) Pub. Date: Sep. 24, 2026

(54) METHOD FOR THE PRODUCTION OF DIETARY FIBERS INTENDED FOR THE FOOD INDUSTRY

(71) Applicant: INDUSTRIE ROLLI ALIMENTARI S.P.A., Roseto Degli Abruzzi (TE) (IT)

(72) Inventor: Gian Paolo ROLLI, FELINO, Frazione S. Michele di Tiorre (IT)

(21) Appl. No.: 19/475,946

(22) PCT Filed: Apr. 17, 2023
(86) PCT No.: PCT/IT2023/000013

§ 371 Date: Oct. 16, 2025

(51) Int. Cl. A23L 33/22; A01G 22/40; A23L 11/00; G01N 33/24

(52) U.S. Cl. CPC A23L 33/22; A01G 22/40; A23L 11/05; G01N 33/245

(57) ABSTRACT

A method for the production of dietary fibers intended for the food industry, which includes the execution of a first agronomic step related to the entire cultivation cycle of legumes, a second analytical step and a third step of mechanical processing of the legumes. The first agronomic step includes at least one sub-step of soil analysis and selection; a sub-step of selection, among the varieties of non-genetically modified legume seeds, of the most suitable one for the characteristics of the selected soils and for the cultivation period; at least one sub-step of checking for the presence of biotic adversities and/or infestations and their suppression by way of selected pesticides; a sub-step of harvesting dependent on the spot detection of the presence on the cultivated legumes of pesticide residues of less than 0.01 mg/kg.

### CROSS-REFERENCE TO RELATED APPLICATIONS

This application is a 35 U.S.C. § 371 National Stage patent application of PCT/IT2023/000013 filed 17 Apr. 2023, the disclosure of which is incorporated herein by reference in its entirety.

### TECHNICAL FIELD

The present disclosure relates to a method for the production of dietary fibers intended for the food industry.

### BACKGROUND

Dietary fiber is not a nutrient but still plays an important role in human health.

As defined by the World Health Organization (WHO), the Food and Agriculture Organization (FAO) and the American Association of Cereal Chemists (AACC), dietary fiber is a polysaccharide with ten or more monomeric units that is not hydrolyzed by endogenous hormones in the small intestine.

Among the main beneficial effects induced by the consumption of dietary fiber, the following can be mentioned: increasing the speed of intestinal transit, as well as decreasing and slowing the assimilation of nutrients; prolonging the sense of satiety, reducing the postprandial glycemic peak and the insulin response; the prebiotic effect, i.e., the possibility to ferment (fermentability) by virtue of the action of intestinal microorganisms, with the consequent forming of compounds that have a beneficial effect on the body.

Moreover, it is evident that in modern society, ready-to-eat food products have become widespread (for example, sports bars, microwaveable ready meals, etc.) in the formulation of which various ingredients are used.

Moreover, it is known that dietary fibers can contribute to an improved (i.e., slower and more controlled) glycemic response, and, in general, fiber-rich foods are given a lower glycemic index (GI) value. Foods with a high GI value release glucose rapidly into the bloodstream (i.e., cause a rapid glycemic response), while foods with a low GI value release glucose more slowly into the bloodstream and result in a better glycemic and insulinemic response. They can also modulate the oxidation of macronutrients (fats). Recently, there has been an increase in public and commercial interest in the concept of GI and its possible inclusion in food labels, both as an aid to diabetes management and to indicate potential foods that can aid weight loss and weight management.

Thus, the use of dietary fiber is justified as an ingredient that can improve the nutritional quality of foods and reduce their glycemic index (GI) while increasing the capacity to retain water in the formulation. The latter characteristic varies depending on the botanical species from which the fibers are obtained, and in particular fibers from legumes (preferably peas) are among those characterized by the best quality standards.

Thus, it can be understood how dietary fiber is destined to become a key ingredient for the food industry: for this use, the fiber must have optimal homogeneity characteristics (both dimensional and physicochemical), high quality standards, negligible or no residual amounts of phytopharmaceutical products, and must derive from non-genetically modified plants, characteristics that currently cannot be found in the corresponding products of the known type.

### SUMMARY

The aim of the present disclosure is to solve the above problems by providing a method for the production of dietary fibers intended for the food industry suitable to improve the nutritional quality of the foods that comprise them.

Within this aim, the disclosure provides a method for the production of dietary fibers for the food industry capable of retaining water in the formulation comprising them.

Another feature of the disclosure is to provide a method for the production of dietary fibers intended for the food industry having negligible or no residual amounts of phytopharmaceutical products.

Another feature of the disclosure is to provide a method for the production of dietary fibers intended for the food industry that derive from non-genetically modified plants.

Another feature of the disclosure is to provide a method for the production of dietary fibers intended for the food industry that are dimensionally uniform.

Another feature of the disclosure is to provide a method for the production of dietary fibers intended for the food industry with uniform chemical/physical properties.

A further feature of the present disclosure is to provide a method for the production of dietary fibers intended for the food industry that has a low cost, is relatively simple to provide in practice and of assured application.

This aim, as well as these and other advantages that will become better apparent hereinafter, are achieved by providing a method for the production of dietary fibers intended for the food industry, comprising the execution of a first agronomic step related to the entire cultivation cycle of legumes, a second analytical step and a third step of mechanical processing of the legumes, characterized in that
said first agronomic step comprises
   at least one sub-step of soil analysis and selection,
   a sub-step of selection, among the varieties of non-genetically modified legume seeds, of the most suitable one for the characteristics of the selected soils and for the cultivation period,
   at least one sub-step of checking for the presence of biotic adversities and/or infestations and their suppression by means of selected pesticides,
   a sub-step of harvesting dependent on the spot detection of the presence on cultivated legumes of pesticide residues of less than 0.01 mg/kg;
   said second analytical step comprises at least one sub-step of detection and quantification of at least one substance selected from pesticides, mycotoxins, heavy metals;
   said third step of mechanical processing of the legumes comprises at least one sub-step chosen from decortication of the legumes, fiber separation, fiber milling, fiber chilling to cryogenic temperatures.

### BRIEF DESCRIPTION OF THE DRAWING

Further characteristics and advantages of the disclosure will become better apparent from the description of a preferred but not exclusive embodiment of the method for the production of dietary fibers intended for the food industry, illustrated by way of non-limiting example in the accompanying drawings, wherein:

FIG. 1 is an exemplifying block diagram of the method for the production of dietary fibers intended for the food industry according to the disclosure.

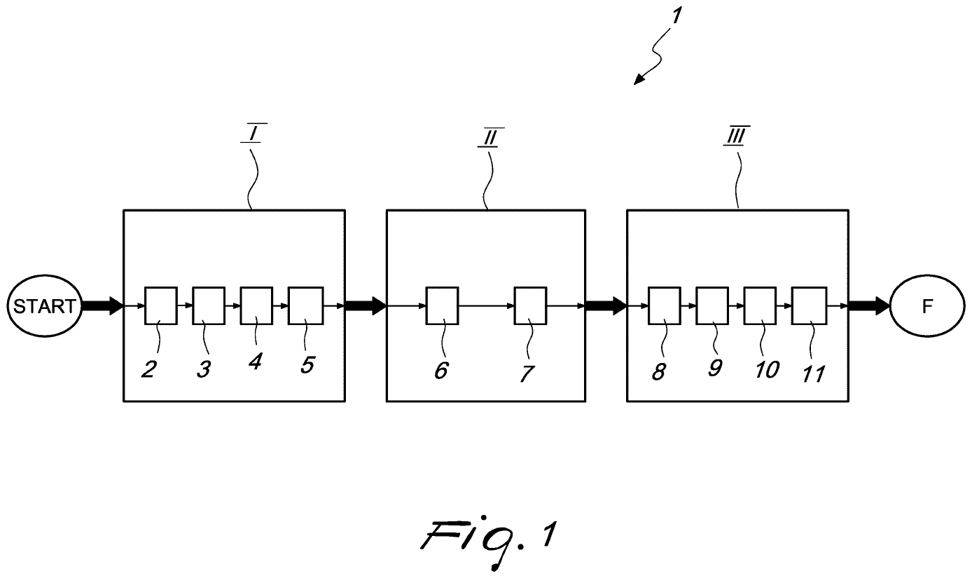

### BRIEF DESCRIPTION OF THE DRAWING

With reference to the figure, a method for the production of dietary fibers F intended for the food industry is generally designated by the reference numeral 1.

The method 1 for the production of dietary fibers F according to the disclosure comprises performing a first agronomic step I related to the entire cultivation cycle of legumes, a second analytical step II, and a third step III of mechanical processing of the legumes.

The first agronomic step I comprises at least one sub-step 2 of soil analysis and selection.

In particular, provisions are made for the execution of a soil analysis to identify the best conditions for the accumulation of mineral micro-and macro-elements of nutritional interest and for the execution of a selection of the soils adapted to achieve the expected production of the vegetable matrix (legumes), without using pesticides or otherwise minimizing their use (study of historical data, e.g., farmbooks).

The fields for cultivation must be selected by avoiding the presence in the vicinity of potentially polluting sites, checking soil texture and slope, water availability and trying to minimize the distance from the processing facility.

In order to optimize production, provisions are also made for the execution of optional preventive weeding and/or fertilization operations: these steps, too, must take into account the need to minimize the release of harmful substances into the environment and therefore shall be carried out using herbicides and/or fertilizers with a low environmental impact that can be absorbed by the soil, leaving negligible residual amounts of potentially polluting substances (in any case, below predefined threshold values).

Subsequently, provisions are made for the execution of a further sub-step 3 of selection, among the non-genetically modified varieties of legume seeds, of the most suitable one for the characteristics of the selected soils and the cultivation period.

As part of this selection, provisions are made for choosing the seed varieties most suitable to obtain a higher amylose content.

In other words, the seeds used must be selected from varieties specifically identified by the words “GMO FREE.” Moreover, they must have specific varietal characteristics that make them suitable to obtain the highest harvest yield and limit the need for treatments: in order to obtain such characteristics, it is necessary to identify the seeds best suited to the characteristics of the soil in which they are to be placed; each individual type of seed guarantees the best yield when placed in a soil that has certain characteristics. The pairing of a specific seed with a respective soil thus allows to ensure optimal productivity and also to guarantee a high quality standard of the legumes obtainable at the end of cultivation. It is evident that legumes that can grow in an ideal environment (from the chemical, physical and pedologic standpoint) will be less prone to diseases, infections and infestations, and therefore will allow to minimize the use of pesticides.

Moreover, the selection of particular varieties is intended to ensure the adequacy of the production of legumes that can be obtained, with reference to the intended use purpose (e.g., selection of specific varieties of legumes comprising a high natural fiber and/or amylose content).

In this case also, it is specified that the choice of fertilizer shall be suitable to ensure that the seeds will be in an environment that corresponds as closely as possible to the ideal one (from a chemical, physical and pedologic standpoint) envisaged by the producer (and/or the breeder, in the case of new plant varieties).

At the end of this step, for a complete identification of the properties and characteristics of the seeds of the selected legumes, the possibility is provided to perform seed germinability tests on the specific batches of seeds purchased (verification of the aptitude of the seed, when placed in suitable external temperature, humidity and lighting conditions, to germinate and produce a new plant), in order to provide experimental support for what has been hypothesized through the selection sub-step 3 .

Moreover, at least one further sub-step 4 of checking for the presence of biotic adversities and/or infestations and for their suppression by means of selected pesticides is also provided, again as part of the first step I.

Once the seeding step has been completed, it is then necessary for a specialized technician to carry out periodic iterated checks of the legumes, which grow after seeding, for the detection of diseases and/or infestations of said plant/vegetables.

Performing periodic and frequent checks of the crops allows to identify the presence of diseases and/or infestations in advance and in a timely manner and to limit any plant protection treatments to restricted areas, or to minimize their dosage by virtue of the minimal incidence of the disease or infestation on the legumes.

For the reasons listed above, it may therefore be necessary in some cases to carry out at least one plant protection treatment by using pesticides.

These treatments allow to maximize productivity (since they protect the cultivated plant/vegetables and fungi from damage that could be generated by diseases and/or infestations).

Moreover, timeliness in the execution of the plant protection treatment in the phases of first onset (even if only sporadic and localized) of diseases and/or infestations allows to limit their spread, also allowing to subject only the affected regions to the site-specific treatment, avoiding any contact of the unaffected regions with the plant protection products.

In this case, the use of precision agriculture systems for variable seeding (soil mapping by satellite monitoring or by means of drones, soil analysis) can be particularly advantageous.

Moreover, provisions are made for a check of the crop during the vegetative/cultivation cycle by specialized technicians and for sharing with the farm operator a list of allowed possible pesticides, making provisions for the adoption of Decision Support Systems (DSS).

The precision agriculture systems provided for crop checking during the vegetative/cultivation cycle (checking by satellite monitoring or by means of drones to identify the only regions within the fields that would need pesticide applications) allow to identify precisely the growing conditions and the presence of any adversities, monitoring extremely small areas (potentially even each individual plant).

The monitoring systems provided by precision agriculture also have the goal of limiting the presence of factors that can lead to the forming of secondary metabolites (produced by plants in stressful situations) that are normally present in plants and can also have dual nutritional/antinutritional effects (for example, the generation of phytates, saponins, or polyphenols/tannins).

The farm technician can then choose, together with the farm operator, the pesticide to be applied, based on low residuality and pre-harvest interval (using a database of low-residuality pesticides and a mathematical modeling system that, as a function of climate characteristics, estimates the time to ripeness/harvesting, combining them with the need to minimize, at that time, pesticide residuality).

At this point it is possible to perform a pre-harvest sampling, performing on these samples respective analyses and checks of the absence of pesticides (below a predefined threshold value). Moreover, it is appropriate to perform a pre-harvest verification of the moisture content of field-dried matrices and of their mycotoxin content.

During a harvesting sub-step 5, which is dependent on the spot detection of the presence, on the cultivated legumes, of pesticide residues below 0.01 mg/kg (or even more preferably <0.005 mg/kg, i.e., ppm), the legumes are harvested.

The second analytical step II comprises at least one sub-step of detection and quantification of at least one substance chosen from pesticides, mycotoxins, heavy metals.

In particular, this second analytical step II comprises a quali-quantitative analysis 6 by gas chromatography and liquid chromatography, both interfaced with mass spectrometry for the identification and quantification of pesticide molecules and/or their derivatives as well as mycotoxins.

Moreover, the second analytical step II provides for performing a quali-quantitative analysis 7 through inductively coupled plasma with mass spectrometry for the identification and quantification of heavy metals.

The third step III of mechanical processing of the legumes comprises at least one sub-step chosen from legume decortication 8, fiber separation 9, fiber milling 10 and fiber chilling to cryogenic temperatures 11.

More specifically, it is specified that the first agronomic step I comprises performing: a preventive, chemical, physical and pedological analysis 2 of the soils intended for cultivation, in order to identify their composition, hydrological characteristics, and to verify the absence of pathogens, pest organisms, and pollutants; a selection 3, among the natural seeds of non-genetically modified legumes, of those best suited to the soil parameters identified previously; the execution of iterated periodic checks 4 on the legumes that grow after seeding in order to reveal biotic adversities and/or infection thereof and select a correct dosage of pesticide for plant protection treatment, the correct dosage depending on the degree of an ongoing disease, infestation, and/or infection and on the stage of growth of the legume, which is followed by the execution of at least one plant protection treatment using specific pesticides.

Moreover, provisions are made for the execution, close to the harvest period, of periodic iterated spot checks of the legumes to measure the residual concentration of pesticides by: collecting samples of legumes and measuring the residual concentration of pesticides in the samples in specific laboratories (which are specialized and accredited). It is specified that a time comprised between 2 and 24 hours elapses between the collection of cultivated legume samples and the operations to measure the residual concentration of pesticides in the laboratory (in order to ensure maximum reliability of the measurements performed).

At the end of these operations for iterated control on samples, and following the verification of a presence of pesticide residues below the threshold of interest (i.e., 0.01 mg/kg or ppm, or in some cases, 0.005 mg/kg or ppm), the cultivated legumes are harvested under ideal ripening conditions.

Moreover, it is specified that the execution of a plant protection treatment (defined within sub-step 4) provides for selecting a specific formulation of the pesticide to be used, defining the dosage of that pesticide, identifying the mode of pesticide administration, identifying the cultivated soil regions to be treated with the pesticide, according to principles that belong to precision agriculture, and detecting the environmental and climatic conditions in which to carry out the treatment with the pesticide.

Application of the method according to the disclosure provides that the pesticides are of a type chosen from herbicides, insecticides, acaricides, fungicides and limacides.

As regards herbicides, provision is made for the adoption of those selected from aclonifen, bentazon, chloridazon, chloropropane, clethodim, clomazone, clopyralid, cycloxydim, Dicamba, fenoxaprop-p-ethyl, Fluazifop, p-butyl, flufenacet, imazamox, lenacil, linuron, metamitron, metazachlor, s-metolachlor, metribuzin, napropamide, oxadiazon, pendimethalin, phenmedipham, propaquizafop, propyzamide, pyridate, quizalofop, p-ethyl, quizalofop p-ethyl D-isomer, rimsulfuron, and triallate.

As regards insecticides, provision is made for the adoption of those selected from abamectin, acetamiprid, acrinathrin, alpha-cypermethrin, azadirachtin, benfluralin, bufoprezin, chlorantraniliprole, chlorpyrifos, chlorpyrifos-methyl, cypermethrin (sum of alpha and zeta isomers), deltamethrin, emamectin benzoate, esfenvalerate, etofenprox, flonicamid, tau-fluvalinate, formetanate, phosmet, imidacloprid, indoxacarb, lambda-cyhalothrin, metaflumizone, methoxyfenozide, pirimicarb, pymetrozine, pyrethrins, spinosad, spirotetramat, tefluthrin, thiacloprid, thiamethoxam, and zeta-cypermethrin.

As regards acaricides, provision is made for the adoption of those selected from bifenazate, clofentezine, etoxazole, fenpyroximate, hexythiazox, spiromesifen and tebufenpyrad.

As regards fungicides, provision is made for the adoption of those selected from acibenzolar-S-methyl, ametoctradin, azoxystrobin, benalaxil, boscalid, bupirimate, cyazofamid, cyflufenamid, cymoxanil, cyproconazole, cyprodinil, diphenoconazole, dimethomorph, famoxadone, fenbuconazole, fenhexamid, fluopicolide, fluazinam, fludioxonil, fosetyl aluminum, iprovalicarb, mandipropamid, meptyldinocap, metalaxyl (isomer sum), metalaxyl-M, myclobutanil, penconazole, copper/copper products, propamocarb, pyraclostrobin, pyrimethanil, tebuconazole, tetraconazole, trifloxystrobin, triadimenol, and sulfur.

As regards limacides, provision is made for the adoption of those selected from ferric phosphate and metaldehyde.

As already described above, the second analytical step II provides for performing a quali-quantitative analysis 6 by gas chromatography and liquid chromatography, both interfaced with mass spectrometry for the identification and quantification of molecules of pesticides and/or derivatives thereof as well as of mycotoxins, and a quali-quantitative analysis 7 by inductively coupled plasma with mass spectrometry for the identification and quantification of heavy metals.

Based on the data collected with analyses 6 and 7, it is possible to perform an ongoing update, at least annually, preferably at least semiannually, even more preferably at least quarterly, of the molecule databases and of the methods for molecule analysis (as well as any new molecules of interest).

This may be done by providing for the use of accredited/accreditable analytical methods.

In this context, a verification of the absence of the molecules of interest may be performed, comprising performing a pre-harvest analysis on the fresh vegetable matrices, repeating the analyses in the post-harvest fresh vegetable matrix delivery step, and final verification on the finished products.

Said sub-step 6, 7 of detection and quantification of at least one substance chosen from pesticides, mycotoxins, heavy metals can advantageously be carried out by means of instruments chosen from gas chromatographs with specific detectors (ECD, NPD, FD), gas chromatographs coupled with mass spectrometers, liquid chromatographs, with spectrophotometric detectors (diode array), liquid chromatographs coupled to UPLC-MS (Ultra Performance Liquid Chromatography-Mass Spectrometry) type mass spectrometers, and HPLC (High Performance Liquid Chromatography) atomic absorption spectrophotometers.

The at least one legume decortication sub-step 8 provides for: the storage of the legumes in a controlled environment by means of techniques chosen from nitrogen atmosphere, inert gas atmosphere, freezing, etc.; monitoring of mycotoxin content; actual mechanical decortication of the legumes; and milling of the husks previously separated from the rest of the legumes until a powder is obtained in which at least 80% by mass has a particle size distribution comprised between 100 μm and 300 μm.

It is specified that the sub-steps of chilling the fibers F to cryogenic temperatures 11 and milling 10 of the fibers F may also be consecutive: in this case the chilling 11 to cryogenic temperatures increases the fragility of the dietary fibers F and the efficiency of the milling 10.

It is specified that chilling 11 to cryogenic temperatures is carried out by means of a refrigeration unit suitable for the delivery of a carrier fluid at a temperature below −150° C.

Fiber milling 10 may be performed by means of a technique chosen between micronization and cryomilling until a powder is obtained in which at least 80% by mass has a comprised particle size distribution not exceeding 100 μm.

Finally, it is specified that the first agronomic step may advantageously comprise an administration of additives, of the type of biostimulants and the like, to the soil and/or seeds and/or legume plants, at any step of their life cycle, in order to increase the content of said microelements in the produced legumes.

The fibers F thus produced will be suitable to be used in bakery products: vegetable fibers F will be added in confectionery, bread and cookie production. The vegetable fibers F will be able to absorb more water and increase the water retention capacity of the finished products, thereby increasing their softness and freshness.

Moreover, the fibers F thus produced will be suitable for use in the meat sector: meat-based products are the main food source of protein and fats for human nutrition. However, excessive intake of meat-based products can also cause problems to human health. It is of great importance to reduce the fat content in meat-based products. Like a sort of functional nutrient, natural vegetable fiber has been used increasingly in meat processing to optimize composition, boost nutritional content, increase production yield and extend shelf life. The vegetable fiber F obtained through method 1 according to the disclosure can therefore be widely used in cured meats and cured sausages, sausages, meatballs and other products.

Moreover, the fibers F thus produced are also suitable for use in the dairy sector: the vegetable fiber F can be used as a source of nutrition for active bacteria. The vegetable fiber F can be added to dairy products to improve the shelf life of the finished product. By way of example, it is noted that water-soluble vegetable fiber is more suitable for addition to infant formula and powdered milk for the elderly. Infants, young children and the elderly have a limited ability to digest and absorb food and need to supplement a large amount of calcium.

The vegetable fiber F can also be used in puffed foods, puddings, jams, jellies, candies and many others. Experts believe that high-fiber foods will become increasingly important over the course of the century. Once these foods are fully developed, they will allow the public to have more diversified food choices and a balanced diet.

Moreover, applications of vegetable fibers F are also provided in the beverage sector: in recent years, vegetable fiber has been used for beverage formulation. In fact, the vegetable fiber F can thus be added to various products of the sector, namely: sports drinks, vegetable protein drinks, and fruit juices. High-fiber beverages containing vegetable fibers F do not have a particular odor and maintain a soft taste, which makes them more palatable to a wide segment of consumers.

Steps I and II of the method 1 according to the disclosure ensure the following properties: absence of gluten; absence of genetically modified organisms; absence of pesticide residues (residual presence of pesticides less than 0.01 mg/kg and, where allowed by the quantification limit of the individual molecule, less than 0.005 mg/kg); presence and bioavailability of microelements of nutritional importance and naturally occurring in vegetable matrices (for example, minerals such as iron, zinc, calcium, and magnesium).

Moreover, step 1, if it is enriched through an administration of additives, of the type of biostimulants and the like, to the soil and/or seeds and/or legume plants, may allow the final product (the fiber F) to have the following characteristics: presence and bioavailability of microelements of nutritional importance and increased in vegetable matrices by means of the biostimulants (for example, minerals such as selenium, and/or zinc, and/or iodine).

The third step III provides for a first milling 10 with a roller mill which allows to obtain a coarse fiber with a particle size distribution comprised between 300 and 100 microns (approximately 80%) and a subsequent finer milling 10, micronization performed with different techniques (mainly micronization mill, but also cryomilling) allows to obtain a fine fiber with a particle size distribution on the order of approximately 100 microns.

Advantageously, the present disclosure solves the problems described above by providing a method 1 for the production of dietary fibers F intended for the food industry suitable to improve the nutritional quality of the foods that comprise them.

Conveniently, the method according to the disclosure generates fibers F capable of retaining water in the formulation that comprises them.

Advantageously, the method according to the disclosure generates fibers F having negligible or no residual amounts of phytopharmaceutical products.

Favorably, the method according to the disclosure generates fibers F derived from non-genetically modified vegetables.

Positively, the method according to the disclosure generates dimensionally uniform fibers F.

Usefully, the method according to the disclosure generates fibers F with uniform chemical/physical properties.

Positively, the method according to the disclosure is relatively simple to provide in practice and low in cost: these characteristics make the method according to the disclosure an innovation of assured application.

The disclosure thus conceived is susceptible of numerous modifications and variations, all of which are within the scope of the accompanying claims; all the details may furthermore be replaced with other technically equivalent elements.

In the embodiments shown, individual characteristics, given in relation to specific examples, may actually be interchanged with other different characteristics that exist in other embodiments.

In practice, the materials used, as well as the dimensions, may be any according to the requirements and the state of the art.

1-11. (canceled)

12. A method for the production of dietary fibers intended for the food industry, comprising the execution of a first agronomic step related to an entire cultivation cycle of legumes, a second analytical step and a third step of mechanical processing of the legumes, wherein
said first agronomic step comprises
at least one sub-step of soil analysis and selection,
a sub-step of selection, among the varieties of non-genetically modified legume seeds, of the most suitable one for the characteristics of the selected soils and for the cultivation period,
at least one sub-step of checking for the presence of biotic adversities and/or infestations and suppression thereof by way of selected pesticides,
a sub-step of harvesting dependent on spot detection of the presence on cultivated legumes of pesticide residues of less than 0.01 mg/kg;
said second analytical step comprises at least one sub-step of detection and quantification of at least one substance selected from pesticides, mycotoxins, heavy metals;
said third step of mechanical processing of the legumes comprises at least one sub-step chosen from decortication of the legumes, fiber separation, fiber milling, fiber chilling to cryogenic temperatures.

13. The method according to claim 12, wherein said first agronomic step includes:
performing a preventive, chemical, physical and pedological analysis of the soils intended for cultivation, in order to identify their composition, hydrological characteristics, and to verify the absence of pathogens, pest organisms, and pollutants, thus deriving soil parameters;
selecting, among natural seeds of non-genetically modified legumes, the natural seeds best suited to the soil parameters identified previously;
performing iterated periodic checks on the legumes that grow after seeding in order to reveal biotic adversities and/or infection of said legumes and select a correct dosage of pesticide for plant protection treatment, a correct dosage depending on a degree of an ongoing disease, infestation, and/or infection and on a stage of growth of the legume;
performing at least one plant protection treatment using active ingredients selected from insecticides, herbicides, acaricides, limacides, and fungicides;
close to a harvest period, performing periodic iterated spot checks of the legumes to measure a residual concentration of pesticides by:
collecting samples of legumes and
measuring residual concentration of pesticides in samples in a laboratory, in which a time comprised between 2 and 24 hours elapses between the sub-steps of collection of cultivated legume samples and the operations for measuring the residual concentration of pesticides in the laboratory; and
harvesting the cultivated legumes when ripe and only when the residual concentration of pesticides is lower than 0.01 mg/kg.

14. The method according to claim 13, wherein said at least one sub-step of carrying out a plant protection treatment provides for the selection
of a specific formulation of the pesticide in use,
of the dosage of the pesticide in use,
of a mode of administration of the pesticide in use,
of the cultivated soil regions to be treated with the pesticide, according to principles that belong to precision agriculture,
of environmental and climatic conditions in which to carry out the treatment with the pesticide.

15. The method according to claim 13, wherein said pesticides are of a type selected from
Herbicides selected from aclonifen, bentazon, chloridazon, chloropropane, clethodim, clomazone, clopyralid, cycloxydim, Dicamba, fenoxaprop-p-ethyl, Fluazifop, p-butyl, flufenacet, imazamox, lenacil, linuron, metamitron, metazachlor, s-metolachlor, metribuzin, napropamide, oxadiazon, pendimethalin, phenmedipham, propaquizafop, propyzamide, pyridate, quizalofop, p-ethyl, quizalofop p-ethyl D-isomer, rimsulfuron, and triallate;
insecticides selected from abamectin, acetamiprid, acrinathrin, alpha-cypermethrin, azadirachtin, benfluralin, bufoprezin, chlorantraniliprole, chlorpyrifos, chlorpyrifos-methyl, cypermethrin (sum of alpha and zeta isomers), deltamethrin, emamectin benzoate, esfenvalerate, etofenprox, flonicamid, tau-fluvalinate, formetanate, phosmet, imidacloprid, indoxacarb, lambda-cyhalothrin, metaflumizone, methoxyfenozide, pirimicarb, pymetrozine, pyrethrins, spinosad, spirotetramat, tefluthrin, thiacloprid, thiamethoxam, and zeta-cypermethrin;
acaricides selected from bifenazate, clofentezine, etoxazole, fenpyroximate, hexythiazox, spiromesifen and tebufenpyrad;
fungicides selected from acibenzolar-S-methyl, ametoctradin, azoxystrobin, benalaxil, boscalid, bupirimate, cyazofamid, cyflufenamid, cymoxanil, cyproconazole, cyprodinil, diphenoconazole, dimethomorph, famoxadone, fenbuconazole, fenhexamid, fluopicolide, fluazinam, fludioxonil, fosetyl aluminum, iprovalicarb, mandipropamid, meptyldinocap, metalaxyl (isomer sum), metalaxyl-M, myclobutanil, penconazole, copper/copper products, propamocarb, pyraclostrobin, pyrimethanil, tebuconazole, tetraconazole, trifloxystrobin, triadimenol, and sulfur;
limacides selected from ferric phosphate and metaldehyde.

16. The method according to claim 12, wherein said sub-step of detecting and quantifying at least one substance selected from pesticides, mycotoxins, heavy metals comprises:
a quali-quantitative analysis by gas chromatography and liquid chromatography, both interfaced with mass spectrometry, for identification and quantification of molecules of pesticides and derivatives thereof and mycotoxins;
a quali-quantitative analysis through inductively coupled plasma with mass spectrometry for the identification and quantification of heavy metals;
an ongoing update, at least annually, preferably at least semiannually, even more preferably at least quarterly, of molecule databases and of the methods for molecule analysis;
a verification of the absence of the molecules of interest, includes performing a pre-harvest analysis on the fresh vegetable matrices, repeating the analyses during the post-harvest fresh vegetable matrix delivery step, and final verification on the finished products.

17. The method according to claim 12, wherein said sub-step of detection and quantification of at least one substance chosen from pesticides, mycotoxins, heavy metals is carried out by way of instruments chosen from gas chromatographs with specific detectors (ECD, NPD, FD), gas chromatographs coupled to mass spectrometers, liquid chromatographs, with spectrophotometric detectors (diode arrays), liquid chromatographs coupled to UPLC-MS (Ultra Performance Liquid Chromatography Mass Spectrometry) type mass spectrometers, and HPLC (High Performance Liquid Chromatography) atomic absorption spectrophotometers.

18. The method according to claim 12, wherein at least one sub-step of legume decortication involves storage of the legumes in a controlled environment by way of techniques chosen from nitrogen atmosphere, inert gas atmosphere, freezing, etc.;
monitoring the mycotoxin content;
mechanical decortication of the legumes;
milling of the husks previously separated from the rest of the legumes until a powder is obtained of which at least 80% by mass has a particle size distribution comprised between 100 μm and 300 μm.

19. The method according to claim 12, wherein said sub-steps of chilling the fibers to cryogenic temperatures and of milling the fibers are consecutive, said chilling to cryogenic temperatures increasing the fragility of said dietary fibers, with consequent greater milling efficiency.

20. The method according to claim 19, wherein said chilling to cryogenic temperatures is performed by way of a refrigeration unit suitable for delivering a carrier fluid at a temperature below −150° C.

21. The method according to claim 12, wherein said milling of the fibers is performed by way of a technique chosen between micronization and cryomilling until a powder is obtained of which at least 80% by mass has a comprised particle size distribution not exceeding 100 μm.

22. The method according to claim 12, wherein said first agronomic step comprises an administration of additives, of the type of biostimulants, to the soil and/or seeds and/or legume plants at any stage of life cycle thereof in order to increase a content of said microelements in the produced legumes.
